(19) United States
(12) Patent Application Publication
(10) Pub. No.: US 2003/0020597 A1
(43) Pub. Date: Jan. 30, 2003

(54) System for displaying on-sale items in retail stores

(76) Inventor: Irwin N. Goldfinger, Rye Brook, NY (US)

Correspondence Address: Irwin N. Goldfinger, c/o Innovative Equipment, Ltd., 8 Westchester Plaza, Elmsford, NY, 10523, US

(21) Appl. No.: 09/917,084

(22) Filed: Jul. 30, 2001

(51) Int. Cl. H04Q 5/22

(52) U.S. Cl. 340/10.41; 340/825.49

(57) ABSTRACT

A system for detecting items which are on sale in a store comprising a RF or IR display-receiver under the control of the shopper and a RF or IR tag positioned adjacent to on sale items, whereby the emissions from the display-receiver causes the tag to produce an indication that an item which is on sale is near the shopper.

### CROSS-REFERENCE TO RELATED APPLICATION

There are no related applications.

### BACKGROUND OF THE INVENTION

1. Field of the Invention

This invention relates to display systems for alerting customers to products for sale, particularly in a retail store.

In a preferred embodiment, the system is used in a store, such as a supermarket, general retail store, so-called discount store, warehouse store and similar places of sale.

In one embodiment, the system employs a display-receiver which may be hand-carried by the shopper or attached to the shopping cart. The display-receiver preferably is “active”, that is, it is equipped with radio frequency [RF] or infra-red [IR] emitters which activate the display-receiver as the shopper brings the unit within range of the emitters.

2. Description of Related Art

No “prior art” Is known to Applicant. The closest technique to achieve in-store recognition of sale items are coupons. Retail stores such as supermarkets compete with their rivals by a number of means. One such device is the use of coupons and the like which offer superior prices for one or more products during a given time period.

The coupons may be generated by the store, the chain which own it, or by producers who wish to spur sales of a new product or, in the case of an existing product, to hold or gain market share relative to competitive products.

Coupons are a good marketing tool, but they have real limitations. For example, the shopper must not only save coupons, but remember to take them to the store to be presented to the cashier. Also, the shopper must prepare a list of items for which he or she has coupons and search the store for items to which the coupons relate.

As indicated, coupons have drawbacks which render them significantly less employed than merchandisers wish.

### SUMMARY OF THE DISCLOSURE

In one embodiment of this invention, Radio Frequency [RF] “tags” are positioned near items which are collectively referred to herein as “for sale” items. “For sale” items may be items offered at a special low price or the subject of a promotional campaign. For sale items are on display, such as on the shelves where the items are placed. As the shopper approaches a sale item, his/her RF display-receiver transmits RF signal which activates the tag. The tag, in turn, transmits data stored in it to the shopper's display-receiver which displays the data from the tag, which normally will be the name of the sale item and price. This, of course, alerts the shopper that the on-sale item is on shelving or other display means within a few feet of him or her.

The shopper's display-receiver may be hand-held or attached to the shopping cart. The display-receiver may be of any desired type, such as LED or more advanced screens.

Further, another embodiment of this invention employs infra red [IR] emitters and display-receivers in lieu of RF. In the description following, in order to avoid unnecessary duplication, the acronym RF/IR is employed to indicate that the various components described may be either RF or IR, unless otherwise indicated.

### BRIEF DESCRIPTION OF THE DRAWINGS

FIG. 1 is a view in elevation of retail store shelving supporting “on sale” products. Also shown is an RF/IR tag positioned adjacent the products. A tag preferably is attached to the shelving in close proximity to the on-sale items.

FIG. 2 is a shopping cart having a display-receiver attached in an upright, viewable position.

FIG. 3 is an overhead essentially schematic view showing the cart of FIG. 2 adjacent the RF emitter shown in FIG. 1.

### DETAILED DESCRIPTION

Radio Frequency Identification [RFID] Systems have been used for various purposes other than that of the present invention. Typically, they employ a “tag” transponder and means for ‘reading’ the data stored on the tag. The communication can be by means of electromagnetic means where there is close proximity sufficient for inductive coupling and otherwise via propagating electromagnetic waves for coupling.

In a typical retail store environment, low frequencies such as 100-500 kHz are sufficient for the RF embodiment of this invention, but other frequencies may be employed.

The RF tags of this invention and require memory which may be ROM, RAM, and non-volatile programmable memory for data storage. In addition, a processor is employed.

Active RF tags have a source of power, which may be small batteries, micro or milliwatts. Passive tags do not require an on-board source of power because they are powered by the energy from the display-receiver when it is near, which is the type of system preferred for this invention.

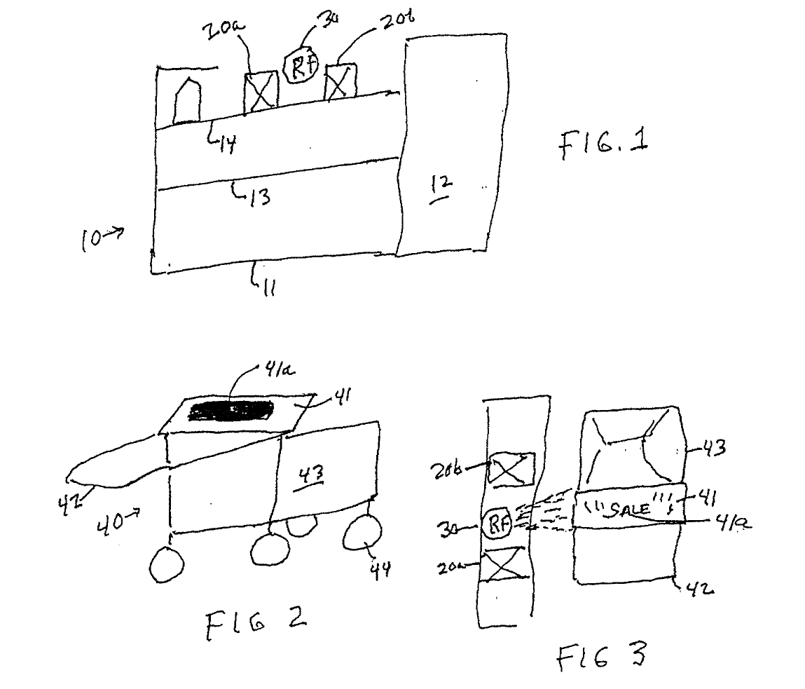

FIG. 1 shows a section of shelving 10 in a typical retail store, including a base 11, side 12 and horizontal shelves 13 and 14. Shelf 14 supports two products 20a and 20b which are on sale. Between them is a RF [or IR] “tag” 30. It should be noted that tag 30 may be placed in almost any position adjacent the sale items, provided the placement does not interfere with the tag's ability to respond to the display-receiver. In the case of IR systems, the tags will be placed so that the IR beam will impinge directly on the display-receiver as it passes by.

It should be noted that it is within the scope of this invention to place numerous tags 30 on shelving throughout a store and, for that matter, several tags along a single aisle. To attend to this, the display-receiver is capable or displaying multiple tag data.

FIG. 2 depicts a typical shopping cart 40 which includes a front handle 42, basket 43 and wheels 44. The cart 40 further has a display-receiver 41 having a display screen 41 a, which may be LED. Screen 41a is not lit when the cart is not in range of a display-receiver.

As mentioned, the display-receiver of this invention my be hand-carried, but certain stores may prefer to attach them to the carts, which does not affect the functioning of the invention.

In FIG. 3, which is a top view of the shelving of FIG. 1 and of the cart 40 adjacent to it. In this view, the RF/IR tag 30 has been energized by display-receiver 41 to produce an indication on display-receiver 41 that the cart is adjacent an item which is on sale. Hence, the display-receiver 41 lights up with the legend “SALE” at 41 a which will alert the shopper he or she is next to a sale item. In addition to such visible indications, an audible tone generator may be employed.

Thus, in the foregoing fashion, RF/IR technology can be applied to retail store shopping and produce far more effective indicators of sale items than traditional means used heretofore.

1. A system for detecting items which are for sale in a store comprising a display-receiver under the control of the shopper and a RF tag positioned adjacent to on sale items, whereby the radio frequency coupling of the display-receiver and the tag produces an indication that an item which is on sale is near the shopper.

2. The invention of claim 2 wherein the display-receiver is attached to a shopping cart.

3. A system for detecting items which are on sale in a store comprising an infra-red display-receiver under the control of the shopper and an infra-red responsive tag positioned adjacent to on sale items, whereby the infra-red emission by the display-receiver activates the tag and the tag produces an infra-red emission which is received by the display-receiver to indicate that an item which is on sale is near the shopper.

4. The invention of claim 3 wherein the display-receiver is attached to a shopping cart.
